(19) United States
(12) Patent Application Publication
(10) Pub. No.: US 2013/0039079 A1
(43) Pub. Date: Feb. 14, 2013

(54) TRAVELING LIGHT TRACK

(71) Applicant: TOM LUTZKE, Whittier, CA (US)

(72) Inventor: TOM LUTZKE, Whittier, CA (US)

(21) Appl. No.: 13/572,704

(22) Filed: Aug. 13, 2012

Related U.S. Application Data
(60) Provisional application No. 61/522,788, filed on Aug. 12, 2011.

(51) Int. Cl. F21V 21/08

(52) U.S. Cl. 362/396

(57) ABSTRACT

The present invention is directed to a traveling light track that satisfies the need for easily relocating a hanging swag light to multiple positions. A traveling light track having features of the present invention comprises an elongated cylindrical shaped tube with a slotted channel suspended from a ceiling, inside of which the actual light chain would be mounted via a swag hook. Thus, sliding the swag hook along the length of the cylindrical tube could relocate the swag light.

### CROSS-REFERENCE TO RELATED APPLICATION

This present application claims the benefit of Provisional Application No. 61/522,788 filed Aug. 12, 2011. The prior application is incorporated herein by reference.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The term “Swag light” is used to describe many different hanging light fixtures, but is more specifically an electric lamp that hangs from a ceiling, often by a metal chain. A swag light is often used to illuminate a specific location by installing a swag hook in the ceiling near the swag light and then hanging a segment of the swag light chain on the swag hook. By relocating a swag light to a specific location, different lighting needs can be achieved, such as general illumination or accent lighting. Although the use of a swag hook allows for the specific placement of a swag light, the positioning of the lighting is limited to where the hook is installed.

To reposition a swag light, additional modifications must be made to the ceiling, either another swag hook must be installed into the ceiling or the existing swag hook must be relocated and the remaining hole repaired. Since different lighting needs may be required from a single light, it is important to be able to reposition the light with ease and convenience. A swag light that can be repositioned with ease and convenience can serve multiple lighting needs. For example, a single swag light over a dining table may be used to illuminate the entire table or be repositioned to the side to provide illumination for a child doing homework.

For the foregoing reasons, there is a need for a device that allows for the hanging and relocation of a swag light with ease and convenience.

### SUMMARY

The present invention is directed to a traveling light track that satisfies the need for mounting a swag light while still allowing for the light to be easily relocated to multiple positions. A traveling light track having features of the present invention comprises an elongated, cylindrical shaped tube suspended from a ceiling. Either end of this tubing would culminate in fitted end caps configured in the form of stoppers and made tight to fit in the end of the tubing like a cork. The fitted end caps can be manufactured of heavy duty corrugated plastic. Running the entire length of the underside of the tubing would be a slotted channel, inside of which the actual light chain would be mounted via a threaded swag hook, lock washer and nut. This swag hook would be able to slide along the length of the cylindrical tube.

The traveling light track can be mounted in the desired position on the ceiling with at least one stud. Optionally, the traveling light track can be mounted via screw eyes or eye bolts and spring wing toggles. The screw eyes or eye bolts would be connected to two threaded hook bolts, mounted in the inverted position. These hook bolts could be secured to the top side of the cylindrical shaped tube by way of two threaded holes or nuts welded near the ends of the unit.

The traveling light track would provide consumers who have swag lighting installed in their homes a simple means of adjusting the positioning of the lighting to accommodate different lighting needs. With the traveling light track, consumers could easily move their swag light to create mood lighting or a specific ambiance. Further, the traveling light track could not only provide a functional solution but also serve as a decorative design element.

### DRAWINGS

FIG. 1 is a profile view of a traveling light track

FIG. 2 is a perspective view of traveling light track in use

### DESCRIPTION

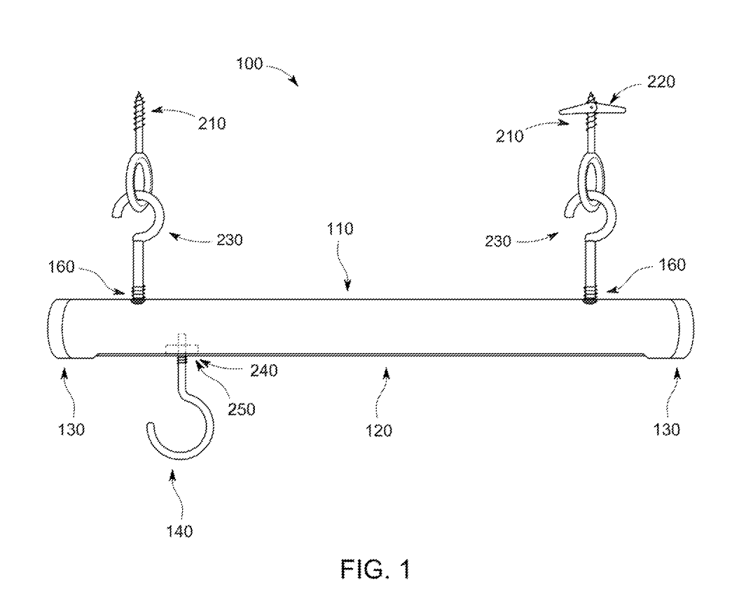

As shown in FIG. 1, a traveling light track 100 comprises a tube 110 with end caps 130 and a swag hook 140. The tube 110 is cylindrical in shape and comprises an end cap 130 on each opposing end, a slotted channel 120 on the underside of the tube 110 along the cylinder axis, and at least one threaded hole 160 on the top side of the tube 110. The swag hook 140 is fastened to the slotted channel 120 and capable of sliding along the length of the slotted channel 120. The threaded hole(s) 160, opposite of the slotted channel 120, allows for the traveling light track 100 to be mounted to a ceiling using a screw eyes or eye bolts 210, and hook bolts 230.

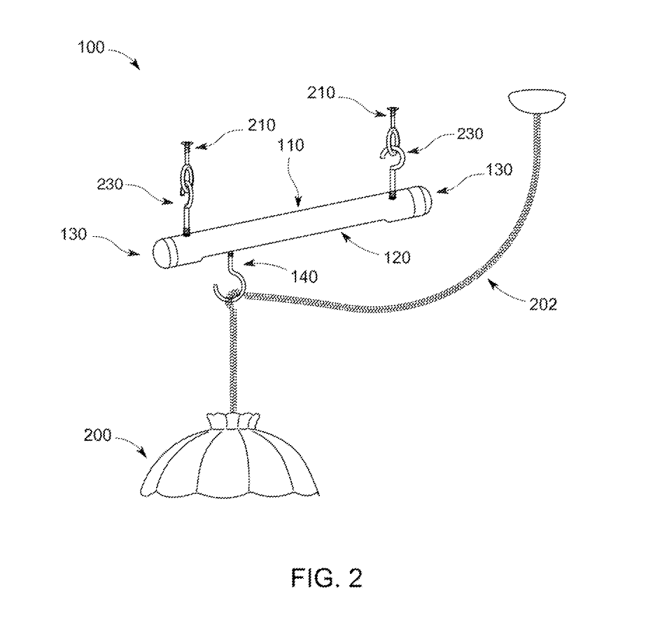

As illustrated in FIGS. 1-2, the tube 110 is a cylinder shape of approximately 17 inches in length and ¾ inch in diameter, and comprised of a rigid material such as metal or plastic. The tube functions as base to attach the end caps 130, swag hook 140, and ceiling mounting hardware; The end caps 130 fit on each opposing end of the tube 110 and the swag hook 140 attaches to the slotted channel 120 on the underside of the tube 110. The tube 110 further accommodates the ceiling mounting hardware by use of threaded holes 160.

The end caps 130 are of a shape which tightly fits each end of the tube 110 and are comprised of a material such as metal or plastic. The end caps 130 function as a cork or cap to close the open ended tube 110.

The slotted channel 120 is a cavity of approximately 14 inches in length along the axis of the cylinder. The slotted channel 120 provides a location for the swag hook 140 to fasten and slide along the length of axis of the tube 110. The swag hook 140 is a curved shaped piece of metal with a threaded rod typically used for hanging lights or other objects. The swag hook 140 can be fastened to the slotted channel 120 using its threaded rod along with a lock washer 240 and nut 250. Once fastened, the swag hook 140 can be reposition on the tube 110 by sliding it along the slotted channel 120.

The threaded holes 160 located on the top side of the tube 110 can accommodate hardware to mount the present invention to a ceiling. Alternatively, the threaded holes 160 can be substituted for nuts welded or bonded to the tube 110. The threaded holes 160 or nuts accommodate fasteners for mounting the present invention to a ceiling, including screw eyes or eye bolts 210, and hook bolts 230. Eye bolts 210 can be attached to the ceiling using spring wing toggles 220 where necessary, such as where the present invention is mounted to a section of ceiling drywall with no underlying studs. The hook bolts 230 can attach to the screw eyes/eye bolts 210, allowing the present invention to be suspended from a ceiling.

Referring now to FIG. 2, the present invention is used by first mounting the device to the ceiling in a user-selected position near swag or hanging light fixture 200. Once mounted to the ceiling, the user may hang a section of the hanging light fixture chain 202 on the swag hook 140. When the user wants to reposition the location of the light fixture 200 along the tube 110, they simply need to slide the light fixture 200 hanging from the swag hook 140 in either direction along the tube 110. Thus the light fixture 200, which was once limited to a single hanging position, may now be easily repositioned on the ceiling.

It is conceivable that the tube be rectangular in shape, and not limited to the shape of a cylinder, as long as there is a slotted channel 120 that provides a location for the swag hook 140 to fasten and slide along the length of axis of the tube 110.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially scientists, engineers and practitioners in the art who are not familiar with patent or legal terms or phraseology, to determine quickly from a cursory inspection the nature and essence of the technical disclosure of the application.

What is claimed is:

1. A device for measuring fluorescence, luminescence, scattering and transmission of light for diagnostics comprising at least two light illuminators that form illumination of a working field, an optical system, a detector, an attachment point for a specimen, a solid carrier of a specimen for analysis, wherein a first group of screens and a second group of screens are present, the first group having at least two screens and the second group having at least two screens, where the screens are placed behind rear a surface of the specimen solid carrier, and said at least two light illuminators contain absorbents for suppressing reflected illumination from a front surface of the specimen solid carrier and surfaces of the screens, where the screens of the first group are positioned perpendicularly to an optical axis of a recording system and the screens of the second group are positioned perpendicularly to optical axes of said at least two light illuminators.

2. The device of claim 1, wherein a first screen from the first group is made so that it can reflect or retroreflect light fluxes of first and second illuminators and is positioned at a minimal distance from 0.01 mm through 10.00 mm from a rear surface of an object solid carrier, where a front surface of the first screen has a reflective or retroreflective layer.

3. The device of claim 2, wherein an attachment point of a holder for the object solid carrier provides a possibility to position the first screen of the first group behind a rear surface of the object solid carrier and to remove the object solid carrier from a field of view.

4. The device of claim 1, wherein a second screen of the first group of screens is positioned relative to a rear surface of the object solid carrier at a distance exceeding a distance from a point of intersection of lower flux boundaries and side boundaries of an optical cone of the recording system, where a front surface of the second screen of the first group of screens has a light-absorbing layer.

5. The device of claim 1, wherein a third screen of the first group of screens is placed behind a second screen of the first group, where a front surface of the third screen is made as a light-scattering surface.

6. The device of claim 1, wherein there is an additional attachment point for second and third screens of the first group of screens and it is possible to remove the second screen from an area of an optical cone of the recording system.

7. The device of claim 1, wherein there is at least one additional third light source, where the at least one additional third light source illuminates a front surface of a third screen, butt-end surfaces of the third screen, or a rear surface of the third screen.

8. The device of claim 1, wherein there are additional attachment points for a first and second screen of the second group of screens which make it possible to move in and remove the screens from the trajectory of the optical axes of the illuminators, where an attachment point of first and second screens of the second group is made using a hinge joint between the attachment point and the screens, and it is possible to turn the screens relative to the optical axes of the illuminators.

9. The device of claim 1, wherein the first screen of the second group has a light-reflective layer, and the second screen of the second group has a retroreflective surface.

10. The device of claim 1, wherein there is an additional third screen of the second group which is positioned behind first and second screens of the second group, a front surface of the third screen having an absorbing layer.

11. The device of claim 1, wherein the screens are a planar, angular, cylindrical or parabolic element with a reflective, light-absorbing or retroreflective surface.

12. The device of claim 1, wherein a light from the light sources is incident upon a working surface of an object for analysis at an angle α to an optical axis of the recording system in the range from 40 to 60 degrees.

13. The device of claim 12, wherein the light sources have an additional light-absorbing coating layered onto a surface of holders with cylindrical apertures, within which light diodes and light-absorbing elements are fixed, that are positioned on the surface of the illuminator casing, where light-absorbing elements have a planar, concave, cylindrical or parabolic shape and where the light sources emits illumination in the range from 300 through 800 nm.

14. The device of claim 1, wherein the specimen solid carrier for analysis is made as a biochip, a cell, or a microplate, said specimen solid carrier for analysis being a biological sample immobilized on a solid planar substrate, a biological sample placed within a flow-through cell, a biological sample placed within a hybridization solution, a sample layered on a flexible substrate pasted to a solid planar substrate, a sample immobilized on a gel substrate, or a biological sample fixed on a chromatographic carrier; said biological sample chosen from a group consisting of DNA, proteins, enzymes, antibodies, antigens, and cells.

15. The method for performing diagnostic tests by illuminating a specimen immobilized on a solid carrier or placed in a reaction solution, wherein:
a) The mode of diagnostics is chosen from a group including measurements of light fluorescence, luminescence, scattering or transmission;
b) One or several screens are in turn introduced into the trajectory of optical axes of illuminators and/or in the trajectory of the optical axis of the recording system;
c) The object for analysis is placed in the object holder and it is introduced into the trajectory of optical axes of illuminators and the recording system;
d) Based on the preliminary image on the display, shooting conditions are chosen and the first image is saved;
e) The object is removed from the trajectories of the optical axes of the illuminators and the recording system;
f) The second image is saved;
g) A differential image of the first and second images is formed;
h) The differential image is multiplied pixel-by-pixel by the normalized coefficients and the processing of the obtained image is started.

16. The method of claim 15, wherein the first screen of the first group placed in the sample holder is used for measuring fluorescence or luminescence.

17. The method of claim 15, wherein the second screen of the first group combined with the first or second screens of the second group is used for measuring fluorescence or luminescence.

18. The method of claim 15, wherein the second screen of the first group combined with the third screens of the second group is used for measuring fluorescence and luminescence.

19. The method of claim 15, wherein the third screen of the first group combined with the third screens of the second group is used for measuring transmission or scattering.

20. The method of claim 15, wherein a transparent layer uniformly fluorescing over the area is used as a reference object for estimating the normalized coefficient, where the fluorescing layer is a film fixed on a plastic, optical glass or quartz carrier.
